(19) United States
(12) Patent Application Publication
(10) Pub. No.: US 2026/0317163 A1
(43) Pub. Date: Oct. 15, 2026

(54) SYSTEM AND METHOD FOR HYDROGEN STORAGE AND SEPARATION OF HYDROGEN BLENDED METHANE-HYDROGEN MIXTURES

(71) Applicant: THE RESEARCH FOUNDATION FOR THE STATE UNIVERSITY OF NEW YORK, Albany, NY (US)

(72) Inventor: Devinder MAHAJAN, South Setauket, NY (US)

(73) Assignee: THE RESEARCH FOUNDATION FOR THE STATE UNIVERSITY OF NEW YORK, Albany, NY (US)

(21) Appl. No.: 19/479,459

(22) PCT Filed: Apr. 26, 2024
(86) PCT No.: PCT/US2024/026363

§ 371 Date: Oct. 28, 2025

Related U.S. Application Data
(60) Provisional application No. 63/498,842, filed on Apr. 28, 2023.

(51) Int. Cl. C01B 3/0026; B01D 53/14; C22C 30/00

(52) U.S. Cl. CPC C01B 3/0026; B01D 53/14; C22C 30/00; B01D 2256/245; B01D 2257/108

(57) ABSTRACT

A method and system for separating hydrogen and methane from a mixture of same, e.g. natural gas, comprising an activated mixed metal hydride and conditions effective, including in one practice select temperatures, pressures, and flow rates whereby unexpected levels of hydrogen absorption occur allowing the methane to be separately recovered for use or storage; the absorbed hydrogen can be used or stored for long durations without degradation. The method can be repeatedly cycled using the same mixed metal hydride solid absorbent to create efficiency.

This application claims priority to U.S. Provisional Patent Application Ser. No. 63/498,842, filed Apr. 28, 2023, the entire contents of which are incorporated herein by reference.

### BACKGROUND

The problems caused by the use of fossil fuels such as coal, natural gas, and oil for energy are well known. Combustion of fossil fuels releases greenhouse gases, such as carbon dioxide, into the atmosphere, which gases are connected to climate change. Moreover, such fuels cause harmful pollution and are non-renewable. Alternative sources for cleaner and renewable energy include wind and solar power both of which, however, can be episodically problematic insofar as each depends on weather conditions. One alternative source not weather dependent is hydrogen (H₂). In addition to being an energy source, hydrogen is also an important industrial chemical. Hydrogen can be generated by electrolysis from water, an abundant resource, and when combusted produces only water vapor as a product. But hydrogen gas has a low density (0.084 g/L) which poses a problem for both storage and transport due to increased cost. Hydrogen is also present in natural gas.

Natural gas comprises hydrogen, methane and various other hydrocarbons, such as ethane, propane, and higher hydrocarbons, as well as non-hydrocarbons such as carbon dioxide, hydrogen sulfide, ammonia, and inert materials, e.g. helium and nitrogen. One or more mercaptan compounds are also typically added to natural gas to odorize it. As a practical matter, hydrogen must be separated from natural gas if one wishes to avoid the use of fossil fuels, such as methane, a co-constituent of natural gas. Ideally, the separation of hydrogen from natural gas for its storage and use would also permit the separate recovery of methane for its own storage and use.

Typically, hydrogen is stored in heavy, rigid, high-pressure cylinders into which the gas is pumped using compressors. Cylinder puncture and the internal high pressure of same creates risk of explosion. Another method to store hydrogen is to liquefy it and store it in an appropriate vessel. This involves significant amounts of cooling energy and risks hydrogen boiling, with attendant loss of the compound, along with the added risk potential explosion if temperature and/or pressure increases too rapidly. Additionally, the low density of hydrogen gas (0.084 g/L) poses a problem for storage and transport due to increased cost.

Mixed metal hydrides are solid phase materials that are stable at room temperature and pressure and can store hydrogen at low temperatures and pressures. However, the chemistry of the reverse reaction of reclaiming hydrogen is complex. In addition, public reports indicate that the thermal decomposition of metal hydrides such as LiAlH₄, NaAlH₄, MgH₂, and Ca(AlH₄)₂ show that the decomposition that is needed in order to release hydrogen occurs over multiple steps which makes the adoption of such systems unsuitable for commercial application.

Hence, methods and systems that can be commercially viable for generating hydrogen by separating it from mixtures such as natural gas, as well as storing it, especially at high volume and for long durations without degradation, are of interest, as well as methods and systems that concurrently separate for storage and use other hydrocarbons such as methane. There is especial interest in a commercially viable system and method that can operate at low pressure (e.g. about 50 to about 1000 psig) and low temperature operation (about 5° C. to about 70° C.), and which also manifests fast hydrogen storage kinetics, including fast hydrogen desorption kinetics, and which can provide a hydrogen purity after separation of greater than 99%, and which can also store hydrogen over longs period of time (one year or more, including several years) without degradation.

### SUMMARY

In one aspect the disclosure relates to a method for separating hydrogen and methane from a gaseous mixture comprising hydrogen and methane, the method comprising (i) providing a zone comprising an activated mixed metal hydride; (ii) passing a flowing gaseous mixture comprising hydrogen and methane through the zone to contact the activated metal hydride under conditions effective to absorb at least a portion of the hydrogen without absorbing a detectable amount of the methane; and (iii) exiting the unabsorbed methane from the zone, the unabsorbed methane substantially free of hydrogen. In one practice the unabsorbed methane of step (iii) contains no more than 100 ppm hydrogen. Another practice comprises (iv) desorbing the hydrogen from the mixed metal hydride, e.g. by increasing the temperature of the mixed metal hydride to about 40° C. to about 120° C.; and (v) exiting the desorbed hydrogen from the zone, the desorbed hydrogen containing no detectable amount of methane. In yet another practice, the method can be repeatedly cycled by repeating steps (ii), and (iii) after step (v). In other embodiments, the gaseous mixture comprises natural gas which comprises one or more of the following impurities: hydrogen sulfide, ammonia, a mercaptan; in one aspect of this practice, the method comprises passing the natural gas through a sulfur guard prior to step (ii) to remove or reduce the amount of the impurities in the natural gas. Serviceable mixed metal hydrides comprise, e.g. mischmetal aluminum alloys, such as without limitation a mischmetal aluminum alloy composition having the formula MmNi_{4.5}Al_{0.5}, wherein Mm represents 49% cerium (Ce), 33% lanthanum (La), 14% neodymium (Nd), and 4% praseodymium (Pr) by weight.

In another aspect, the disclosure relates to a system for separating hydrogen and methane from a mixture comprising hydrogen and methane, the system comprising a zone comprising an activated mixed metal hydride; a first temperature controller to maintain the temperature in the zone at about 5° C. to about 70° C.; a source providing a mixture comprising gaseous hydrogen and methane to the zone at a flow rate of about 5 to about 20 Standard Liters Per Minute (SLPM) and a pressure of about 50 psig to about 500 psig, the source in fluid communication with the zone, wherein at least a portion of the hydrogen is absorbed in the activated metal hydride without substantially absorbing a detectable amount of the methane; and an outlet from the zone whereby the unabsorbed methane substantially free of hydrogen exits the zone, and optionally at least one of the following: one or more collection stations for storing the unabsorbed methane substantially free of hydrogen that exits the zone, or one or more collection stations for storing the desorbed hydrogen that exits the zone. The system can comprise a second temperature controller to increase the temperature of the zone so as to desorb the hydrogen from the mixed metal hydride, and the first temperature controller and the second temperature controller can be the same or different. In another practice, the system comprises a sulfur guard having an inlet connected to the source providing the mixture comprising gaseous hydrogen and methane, and an outlet connected to the zone comprising the activated mixed metal hydride.

In various practices, the disclosure provides a system and method that manifests the following: high volumetric energy density of storing hydrogen, e.g. the capacity to store 2,639 L hydrogen at 90 psig and 5° C. A low mass energy density of storing hydrogen of 0.61 wt % at 90 psig and 5° C. And fast hydrogen absorption/desorption kinetics was fast (less than 5 min).

### BRIEF DESCRIPTION OF THE DRAWINGS

FIG. 1 is a schematic representation of an embodiment of a method and system of the disclosure.

FIG. 2 is a schematic representation of an embodiment of a method and system of the disclosure as used in the examples herein.

FIG. 3 is a graph of hydrogen pressure over time for a system of the disclosure before and after activation of the mixed metal hydride of the example.

FIG. 4 is a graph of data from 20° C. testing with a delivery pressure of 90 psig. The first test shown in red was performed using the Being chiller. The second test shown in blue was performed using the Merlin M3 chiller.

FIG. 5 is a graph of d from 10° C. testing with a delivery pressure of 90 psig. Both tests were performed using the Merlin M3 chiller. The first test is shown in red. The second test is shown in blue

FIG. 6 is a graph of data from 5° C. testing with a delivery pressure of 90 psig. Both tests were performed using the Merlin M3 chiller. The first test is shown in red. The second test is shown in blue.

FIG. 7 is a graph of the performance of the HY-STOR 208 for a delivery pressure of 90 psig and varying tank (zone) temperatures. The data from the first test at each temperature was used to generate this figure.

FIG. 8 is a graph of maximum storage capacity as a function of the temperature of the tank (zone). The data from the first test at each temperature is represented by the red line. Data from the second test at each temperature is shown by the blue line.

FIG. 9 is a graph of maximum weight loading as a function of the temperature of the tank (zone). The data from the first test at each temperature was used to create the figure. M represents the mass of the HY-STOR 208 contained within the tank (zone).

FIG. 10 is a graph of the summary of the hydrogen absorption at a delivery pressure of 90 psig and a tank (zone) temperature of 5° C.

FIG. 11 is a graph of the summary of the hydrogen absorption at a delivery pressure of 90 psig and a tank temperature of 10° C.

FIG. 12 is a graph of the summary of the hydrogen absorption at a delivery pressure of 90 psig and a tank temperature of 5° C.

FIG. 13 is a graph of the summary of hydrogen absorption at a delivery pressure of 90 psig for all test temperatures across the entire range of hydrogen volume added to the system.

FIG. 14 is a graph of the summary of hydrogen absorption at a delivery pressure of 90 psig for all test temperatures during the addition of the first 200 L of hydrogen.

FIG. 15 is a graph showing the comparison of the pressure of the system for nitrogen and hydrogen at different tank (zone) temperatures. The nitrogen line is only for nitrogen addition at 20° C. The delivery pressure is 90 psig.

FIG. 16(a) is a graph showing maximum volumetric storage capacity; FIG. 16(b) is a graph showing maximum weight loading. Both at a delivery pressure of 90 psig and as a function of tank (zone) temperature.

FIG. 17 is a graph of time evolution of the volume of hydrogen absorbed for different tank (zone) temperatures at a delivery pressure of 90 psig.

FIG. 18 is an Arrhenius plot for the exemplified hydriding reaction at a delivery pressure of 90 psig.

FIG. 19 is a graph showing hydrogen absorption data with a delivery pressure of 50 psig and a tank (zone) temperature of 20° C.

FIG. 20 is a graph showing hydrogen absorption data with a delivery pressure of 50 psig and a tank (zone) temperature of 10° C.

FIG. 21 is a graph showing hydrogen absorption data with a delivery pressure of 50 psig and a tank (zone) temperature of 5° C.

FIG. 22 is a graph showing a summary of hydrogen absorption at a delivery pressure of 50 psig for all test temperatures across the entire range of hydrogen volume added to the system.

FIG. 23 is a graph showing a summary of hydrogen absorption at a delivery pressure of 50 psig for all test temperatures during the addition of the first 150 L of hydrogen.

FIG. 24(a) is a plot of maximum volumetric storage capacity and FIG. 24(b) is a plot of maximum weight loading. Both FIGS. 24(a) and 24(b) are at a delivery pressure of 50 psig and as a function of tank (zone) temperature.

FIG. 25 is a graph showing time evolution of the volume of hydrogen absorbed for different tank (zone) temperatures at a delivery pressure of 50 psig.

FIG. 26 is an Arrhenius plot for the hydriding reaction at a delivery pressure of 50 psig.

FIG. 27 is a graph of a summary of the hydrogen absorption at different delivery pressures with FIG. 27(a) showing results of absorption at 20° C.; FIG. 27(b) showing results of absorption at 10° C.; and FIG. 27(c) showing results of absorption at 5° C. Data obtained at 50 psig is shown in red. Data obtained at 90 psig is shown in blue.

FIG. 28 is an Arrhenius plot of the results obtained for absorption testing at two different delivery pressures. Results from the 50 psig tests are shown in red. Results from the 90 psig test are shown in blue.

FIG. 29 shows a comparison of the storage capabilities of HY-STOR 208 as a function of temperature and delivery pressure, with FIG. 29(a) showing maximum volumetric storage capacity, and FIG. 29(b) showing maximum weight loading. Results shown in red are obtained from testing at 50 psig. Results shown in blue are obtained from testing at 90 psig.

### DETAILED DESCRIPTION

The ensuing detailed description and reference to any of the figures is exemplary only and not restrictive of the disclosure.

As used herein terms such as “a,” “an,” and “the” are not intended to refer to only a single entity but include the general class of which a specific example may be used for illustration. Terms defined herein in the singular are intended to include those terms defined in the plural and vice versa.

Reference to any numerical range as used herein expressly includes each numerical value (including fractional numbers and whole numbers) encompassed by that range and includes endpoints of that range. For illustrative purposes only, a reference to a range of “0.0001 to 5000” includes whole numbers such as 5000, 4999, 4998 . . . 3, 2, 1; and includes fractional numbers such as 0.00011, 0.00012 . . . 0.1, 0.2, 0.3 . . . 1.1, 1.2, 1.3 . . . 100.5, 100.6 . . . 4900.5, 4990.6, 4990.7 etc.

As used herein, the term “about” includes the value listed and indicates that the value listed may be somewhat altered, as long as the alteration does not result in nonconformance of the article or method or system herein described. For example, the term “about” as used herein can refer to a variation of between ±1% up to ±10%, including any value therebetween, including without limitation ranges within same, such as up to ±1%, between ±1% up to ±8%, between ±1% up to ±5%, between ±1% up to ±3% and the like.

As used herein, the term “substantially” or “substantial” is equally applicable when used in a negative connotation, and refers to a complete or near complete action, characteristic, property, state, structure, item, or result. For example, a surface that is “substantially” flat would either be completely flat or so nearly flat that the effect would be the same as if it were completely flat.

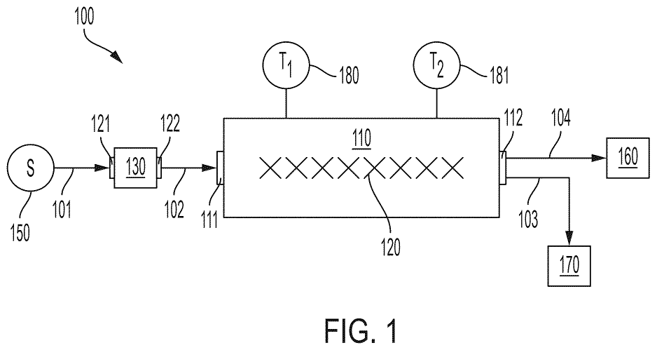

Referring to FIG. 1, thereat is a schematic representation of an exemplary system 100 and method of the disclosure for separating hydrogen and methane from a mixture comprising hydrogen and methane. System 100 comprises zone 110 which can be a vessel or combination of vessels in series or parallel comprised of metal, polymers, or other suitable material of construction as known in the art, including, e.g. a steel cylinder, and each of which can comprise one or more zone inlets 111 and one or more zone outlets. Zone 110 comprises an activated mixed metal hydride 120, e.g. a steel cylinder filled with an activated mixed metal hydride. A source(S) 150 provides a mixture comprising gaseous hydrogen and methane to zone 110. Source 150 can be pressurized and/or additional pumps (not shown) can be employed between it and zone 110 in order to pass the hydrogen and methane as a flowing gaseous mixture through the zone to contact the metal hydride under conditions effective to cause absorption of at least a portion of the hydrogen, e.g. up to about 2 wt % hydrogen can be absorbed based on the total weight of mixed metal hydride in zone 110, without causing absorption of a detectable amount of methane using means of detection known in the art. The term “detectable amount” as used herein includes amounts that are not detectable using commonly available detection methods known in the art, and includes about 0.01 wt % and about 0 wt % and 0 wt % methane. The term “conditions effective” in this regard includes without limitation a temperature in zone 110 at about 5° C. to about 70° C., a flow rate through zone 110 of about 5 to about 20 Standard Liters Per Minute (SLPM), and a pressure of about 50 psig to about 500 psig, including a pressure of about 50 psig to about 90 psig. As shown in FIG. 1, first temperature controller (T₁) 180 as known in the art can be used to maintain the temperature in zone 110 at about 5° C. to about 70° C. In one embodiment, the temperature is about 5° C., the pressure is about 90 psig, and the flow rate is about 20 SLMP.

In one embodiment, source 150 comprises natural gas. Natural gas is a mixture comprising gaseous hydrogen and methane and one or more impurities, such as without limitation, hydrogen sulfide, ammonia, and mercaptans; these impurities adversely affect the absorption capability of the mixed metal hydride over time, e.g., by competing for pores in the mixed metal hydride which would otherwise be available for hydrogen absorption thereby reducing the useful life cycle of the mixed metal hydride. In one practice of this embodiment, natural gas with impurities such as those exemplified is fed from source 150 through line 101 into a sulfur guard 130 via sulfur guard inlet 121. The sulfur guard substantially removes most or all of the impurities from the natural gas so as to either reduce or eliminate these adverse affects thereby extending the life cycle of the mixed metal hydride. Natural gas thus comprising substantially only hydrogen and methane by having had it its impurities so reduced or eliminated by sulfur guard 130 is passed from sulfur guard 130 via sulfur guard outlet 112 to zone 110 and the mixed metal hydride 120. One or more sulfur guards as known in the art, e.g. those commercially available from Shell or Johnson Matthey, such as PURASPEC™, can be employed in series or parallel. Non-limiting examples of serviceable sulfur guards include those that comprise carbon or iron.

As shown in FIG. 1, methane that is unabsorbed by the mixed metal hydride 120 exits zone 110 via zone outlet 112 and passes through line 104 to be stored in one or more storage vessels 160 and/or to be used, e.g. used on demand. In one practice, the unabsorbed methane is substantially free of hydrogen, e.g. the unabsorbed methane contains no more than 100 ppm hydrogen. In one non-limiting practice, a series of zones 110 are connected in series flow to continually to reduce the amount of hydrogen in the unabsorbed methane to no more than 100 ppm levels. Thus, for example, zone outlet 112 is in fluid communication with the next zone inlet and so on.

In one practice, the hydrogen absorbed by the mixed metal hydride 120 is desorbed from same by methods known in the art, including by increasing the temperature of the mixed metal hydride 120 in the zone 110 to about 40° C. to about 120° C. whereupon the hydrogen is released from the mixed metal hydride; at the lower temperatures, hydrogen is desorbed at a slow rate; at the higher temperatures hydrogen is released at an accelerated rate, e.g. in minutes. In one practice, a second temperature controller (T₂) 181 can be used to increase the temperature so as to desorb the hydrogen. The second temperature controller 181 can be the same controller as the first temperature controller 180 or different. The desorbed hydrogen can exit zone 110 via zone outlet 112 (or other outlet from zone 110) and passed through line 103 (or the same line 104 as used for unabsorbed methane can be used) and the desorbed hydrogen can be stored in one or more storage vessels 170 and/or used, e.g. used on demand. In one practice, the hydrogen absorbed by the mixed metal hydride 120 is stored in the activated mixed metal hydride itself for a period of time up to one year. The hydrogen thus stored can be desorbed at that time with no degradation or change in quality.

In one embodiment, the mixed metal hydride comprises a mischmetal aluminum alloy. In a non-limiting example, the mischmetal aluminum alloy comprises a composition having the formula MmNi_{4.5}Al_{0.5}, wherein Mm represents 49% cerium (Ce), 33% lanthanum (La), 14% neodymium (Nd), and 4% praseodymium (Pr) by weight. Such a mischmetal aluminum alloy is commercially available as HY-STOR 208. In one practice, the mixed metal hydride is activated, e.g. to remove water and the like by methods known in the art, e.g. (a) exposing it to a temperature of about 100° C. to 120° C. under a nitrogen atmosphere for about 1 to about 6 hours, or (b) exposing it a temperature of about 60° C. to 80° C. under vacuum for about 1 to about 6 hours, or a combination of (a) and (b).

In one practice, after the hydrogen is desorbed and exits the zone, the method is cycled by repeating the steps of passing a flowing gaseous mixture comprising hydrogen and methane through the zone to contact the activated metal hydride under conditions effective to absorb at least a portion of the hydrogen without absorbing a detectable amount of the methane; and exiting the unabsorbed methane from the zone, the unabsorbed methane substantially free of hydrogen. In one practice, the method can be repeated up to 7000 times. In one practice of cycling, the mixed metal hydride need only be activated once, on the initial cycle and need not be activated again.

In one embodiment, the cycling method comprises feeding a fresh mixture of hydrogen and methane, e.g. a fresh flow of natural gas to the zone. In a second embodiment, the cycling method comprises the unabsorbed methane exiting the zone is fed back into the zone to serve as feed. In a third embodiment of the cycling method, the desorbed hydrogen exiting the zone is fed back into the zone to serve as feed. In a fourth embodiment, combinations of the first, second and third embodiments hereinabove can serve as feed, e.g. a cycling feed can comprise: optionally a fresh mixture of hydrogen and/or exiting unabsorbed methane and/or desorbed exiting hydrogen.

### EXAMPLES

In one aspect, the disclosure relates to addressing the size exclusion of methane and/or interaction between hydrogen atoms with the solid adsorbent. Before any examples herein were conducted, the mixed metal hydride was heated at about 110° C. under nitrogen for 2 to 5 hours to ensure the pores of the solid adsorbent were empty since moisture or other gases can potentially occupy these pores. An alternative method for activation comprises heating the mixed metal hydride at 70° C. under vacuum which ensures that the pores are empty before the hydrogen-methane separation examples.

The examples establish that commercial mixed metal hydrides efficiently and selectively separate methane from hydrogen from a mixture of these two gases under flowing conditions is disclosed, and that this can be applied to natural gas as described herein. Natural gas comprises two types of compounds: hydrocarbons, e.g. ethane, propane and the like, that will behave similar to methane; and non-hydrocarbons. Among the non-hydrocarbons are nitrogen and helium, which are both re inert gases and are essentially non-interactive with the mixed metal hydride. Other non-hydrocarbons, e.g. carbon dioxide, hydrogen sulfide can be present up to 3 mol % each; in the practice herein described, these are removed or reduced to acceptable quantities by the use of a sulfur guard or the like.

### Materials

In the examples the following materials were used: a high-pressure charging hose, ¼″ stainless steel tubing, four ball valves, one needle valve, a pressure transducer (0 to 1,000 psig range), a pressure gauge (0 to 1,000 psig range), a pressure relief valve (1,000 psig burst pressure), a type k surface thermocouple, a type k thermocouple probe and one aluminum gas distribution manifold were all ordered from McMaster-Carr. Two M-Series mass flow meters (5 SLPM/20 SLPM, 100 psig) were ordered from Alicat Scientific. Data readout boxes and a data acquisition box were ordered from Omega. Two chillers were purchased, one from Being, the Merlin M3 chiller was ordered from Thermo Scientific. A RH-5L heater was purchased from USALABs. Ultra-high purity (300 SCF) nitrogen and hydrogen tanks were purchased from General Welding.

### Zone Design

The zone (also referred to herein known as the hydrogen storage system, tank, or cylinder) consisted of fourteen steel cylinders. A mischmetal nickel aluminum alloy, commercially available as HY-STOR 208, was pre-sealed in the cylinders. According to the manufacturer, the HY-STOR 208 material had the following chemical composition: MmLaNi_{4.5}Al_{0.5}. The mischmetal (Mm) is 49% cerium (Ce), 33% lanthanum (La), 14% neodymium (Nd), and 4% praseodymium (Pr) by weight. This material is known to absorb hydrogen. For this study, one of the fourteen tubes were repurposed to conduct hydrogen absorption kinetic testing.

### System

One of the fourteen cylinders was chosen for testing in this study. The cylinder was large with physical dimensions of L=152.4 cm and r=4.45 cm which provided enough volume to conduct a kinetic study. Contained inside the cylinder was the mischmetal nickel aluminum alloy, HY-STOR 208. On one end of the cylinder was two open tubes which were used to flow heat transfer fluid. The heat transfer fluid was deionized water. During the absorption process the storage tube was connected to a circulating chiller. The chillers were cither Being or Merlin M3 chiller from Thermo Scientific. To desorb the stored hydrogen, the cylinder (zone) was heated by connecting to a RH-5L circulating heater from USALAB. Fiberglass heat tape was wrapped around the tank to help insulate and allow isothermal operation. To monitor the temperature of the storage tank, two types of thermocouples were used: 1) Type k surface thermocouple which was connected directly to the surface of the tank, 2) a thermocouple probe, also type K, was secured to the tank by a hose clamp. The surface thermocouple was wired directly to a data acquisition (DAQ) box which was also connected to a laptop to record temperature data. The probe thermocouple was wired to a data readout box for visual representation of the system.

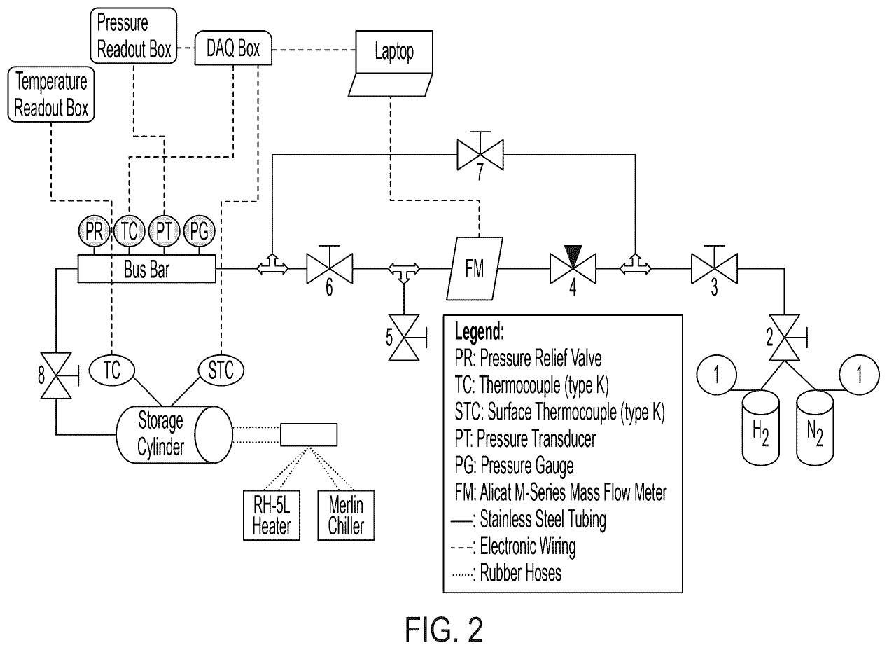

On the other end of the cylinder (zone) was a flared nozzle used for gas inlet and outlet. Since the cylinder (zone) had only one port for both gas inlet/outlet, an exterior system was designed for gas delivery to the tank. This system is referred to herein as the gas distribution system. The gas distribution system was designed so that upon delivery the gas flowed directly from the compressed gas cylinder to the cylinder (zone). During the desorption step, however, the gas could be re-routed directly through the measurement equipment. This allowed for direct quantification of the amount of gas released from the system during desorption. The flow diagram of the assembled unit is shown on FIG. 2.

The equipment used to record data during absorption cycles were contained within the gas distribution system. This equipment included a pressure transducer with a range of 0-1000 psig, which was connected to a pressure readout box which was connected to the data acquisition box. This was done so that the pressure of the system could be seen visually on the readout box, while also collecting the analog signals which may be converted to pressure data. To configure the data acquisition box Instacal, a software program, was used. To display and record the data another software program known as TracerDAQ was used. Furthermore, the gas distribution system contained a pressure gauge (range 0 to 1000 psig) that was used as a reference to help calibrate the other pressure recording equipment. A pressure relief valve with a burst pressure of 1000 psig was included. To collect the flow rate and mass flow data, an M-series mass flow meter from Alicat Scientific was used. Two mass flow meters were used in this iteration of the system. One can record data for hydrogen flow rates up to 5 standard liters per minute (SLPM), the other is capable of measuring flows up to 20 SLPM. Both flow meters are rated for pressures up to 100 psig. The data recorded by the M-series mass flow meter was displayed and logged by Flowvision 2.0, a software program designed by Alicat Scientific. The gas cylinders used in this study were procured from General Welding. The hydrogen tank is 300 standard cubic feet (SCF) of grade 5.0 (ultra-high purity) hydrogen. The nitrogen cylinder was the same size and grade.

### Hydrogen Absorption Procedure

Hydrogen absorption was conducted using the system described above and as schematically represented in FIG. 2. The data collected using this method was used to create pressure, composition, temperature (P-C-T) isotherms as well as to investigate the influence of tank temperature and delivery pressure on absorption rate. This test was done at system pressures of 90 psig and 50 psig and cooling temperatures of 5° C., 10° C., and 20° C. Tests were run using two different flow meters. One of which had a flow range of 0 to 5 SLPM, the other from 0 to 20 SLPM.

The ensuing description is with reference to FIG. 2: the method used in this example was as follows: first, the gas distribution system was connected to the compressed nitrogen tank. The storage system was then filled with N₂ until the pressure inside the system reached the desired delivery pressure. The N₂ was then vented. This procedure was repeated three times, however, after filling the tank with N₂ the third time it was allowed to remain in the system until right before the test began. Then the laptop was turned on and the data collection software was configured. Firstly, Instacal was opened and open communication between the computer and the data acquisition box was ensured. The temperature measurement displayed in Instacal was made sure to be accurate by comparing to the temperature displayed on the chiller and the thermocouple probe secured to the storage tank. It was checked that the pressure transducer was producing an appropriate signal by applying the voltage recorded in Instacal to the calibration curve created earlier. This value was cross referenced with the reading on the pressure readout box as well as the pressure gauge. Once the data acquisition (DAQ) board was configured Instacal was closed and TracerDAQ was opened. Flowvision 2 was opened, and a new log was created. The log was set to record pressure, flow rate, and totalize data. Lastly, a new CSV file was created, and the file path was adjusted in Flowvision to make sure the program would not write over any previous data.

The storage tube was then connected to the chiller via rubber hoses and the hoses were secured using hose clamps. The chiller was set to the desired temperature and the cooling water was allowed to circulate. The tube was given time to reach the set point. The temperature of the tank was monitored by comparing the set point of the chiller to the temperature displayed on the temperature readout box. Once the tube reached the desired temperature the remaining nitrogen was vented from the system. The mass flow meter totalizer was cleared. The logger in Flowvision was started and the TracerDAQ data collection was initiated. The time at which the data collection software were started was recorded. The gas distribution system was quickly connected to the compressed hydrogen tank. Valve one was opened, and the regulator was set to the desired delivery pressure.

Still referring to FIG. 2, valves four, five, and seven were closed. Valves six and eight were opened. Valves two and three were opened and hydrogen was allowed to enter the system from the compressed gas cylinder. Next, the needle valve (valve four) was slowly opened allowing hydrogen to pass through the mass flow meter and into the storage cylinder. The needle valve was carefully operated ensuring the flow rate did not exceed the maximum flow rate. This value was monitored using Flowvision 2. A stable flow rate was achieved, and the system was allowed to fill slowly. The flow rate, pressure, and temperature of the system were monitored. As the test proceeded and the pressure within the system began to approach the delivery pressure the needle valve was continuously opened to maintain the flow rate. Hydrogen was allowed to enter the system until the desired system pressure was reached and the flow rate was below 0.75 SLPM without restriction from the needle valve. At this point the HY-STOR 208 was completely saturated, and the absorption experiment was concluded. Valve three was closed, followed by valves one and two. The logger in Flowvision 2 and TracerDAQ were stopped. The data was saved, the applications closed, and the computer turned off.

### Hydrogen Desorption Procedure

The storage system was then connected to the heater via the same rubber hoses, once again the hoses were secured using hose clamps. The heater was set to 70° C. and allowed to circulate. Valve six was quickly closed and the needle valve (valve four) was also closed. Valve seven was opened. Valve five was slowly opened, ensuring that the flow rate did not exceed the maximum flow rate. Valve four was slowly opened once again, ensuring that the flow rate did not exceed the maximum value. The tank was allowed to heat and empty. The flow rate was continuously monitored, as the temperature of the tank increased the pressure inside the system also increased. This caused the flow rate to increase. To keep the flow rate within range, valve four was continuously closed until a stable flow rate was achieved. The system was allowed to remain in this state until the total volume of hydrogen added during the absorption process was released from the tank. Once the total volume of hydrogen released from the tank equaled the volume of hydrogen added valve five was closed. The system was allowed to remain at 70° C. until the next test is started.

### Activation

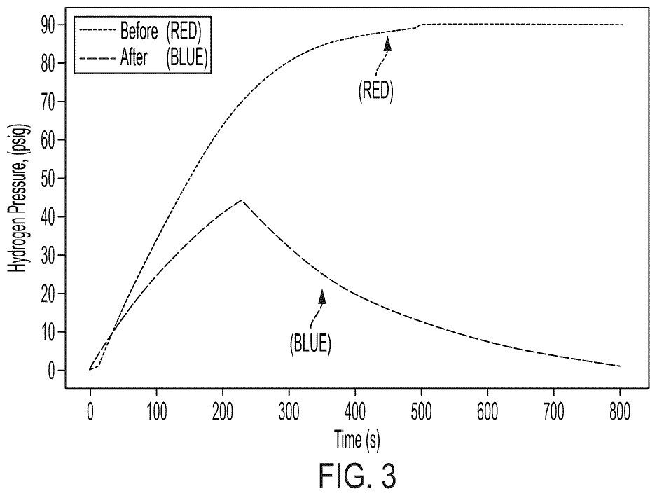

Activation of HY-STOR 208 to remove any oxygen that may occupy pores was achieved by pressurizing the system with hydrogen to form water then removed by heating it. The system needed to remain pressurized and heated for a length of time until the material was activated. This duration depended on several factors such as, the material itself, storage conditions, etc. To characterize the importance of activation, the hydrogen pressure over time was recorded for the system before and after activation. To test the performance of HY-STOR 208 before activation, hydrogen was allowed into the system which was cooled to 20° C. As hydrogen enters the system the pressure rose to 90 psig. As the system pressure approached the delivery pressure the flow rate slowly declined until the flow rate detected by the mass flow meter was 0.00 SLPM. It took approximately 500 seconds for the system to fill and a total of 27 L of hydrogen was added to the tank. The valve was closed, and the pressure of the system was monitored for 10 minutes. The first 5 minutes of this period are shown in FIG. 3. During this duration the pressure did not change significantly, signaling that the HY-STOR 208 was not active. Then the system was heated to 70° C. and allowed to remain pressurized at this temperature for 19.5 hours. Eventually, the pressure inside the system dropped dramatically indicating that the material had been activated. The system was then vented and cooled again to 20° C. Once the system was cooled, 27 L of hydrogen were reintroduced to the system. This time the system filled much faster because the system pressure never approached the delivery pressure. Therefore, the flow rate of hydrogen into the system did not decline as drastically over time. The system took approximately 220 seconds to fill and the point at which 27 L of hydrogen had entered the system can be seen by the apex of the blue line in FIG. 3. Once the tank was filled the valve which allowed hydrogen into the system was closed and the pressure was monitored for 10 minutes and recorded. Rapid sorption of hydrogen caused the system pressure to quickly decline as seen in the figure. After approximately 10 minutes the system pressure reached 0 psig, meaning the 27 L of hydrogen added to the tank had been absorbed by the Hy-Stor 208.

### Runs

The data obtained from the following tests was used to generate P-C-T isotherms. In the construction of the P-C-T isotherms, three distinct phases formed. These phases are referred to as the α, α+β, and β phases. The α phase occurs during the initial introduction of hydrogen into the system. It is characterized by a large increase in the system pressure with respect to a relatively small amount of hydrogen addition. The data represented by the α phase corresponds to hydrogen going into the solid solution. The α phase ends when the solid solution reaches its saturation point. The α+β occurs after the α phase and is characterized by a low increase in the system pressure with respect to a large volume of hydrogen added to the system. During the formation of the α+β phase the metal hydride layer is formed (Jain et al., 2002). Finally, the β phase forms after the completion of the α+β phase and is characterized by another period of rapid pressure increase with respect to hydrogen addition.

Runs at 20° C., 90 psig, and 5 SLPM

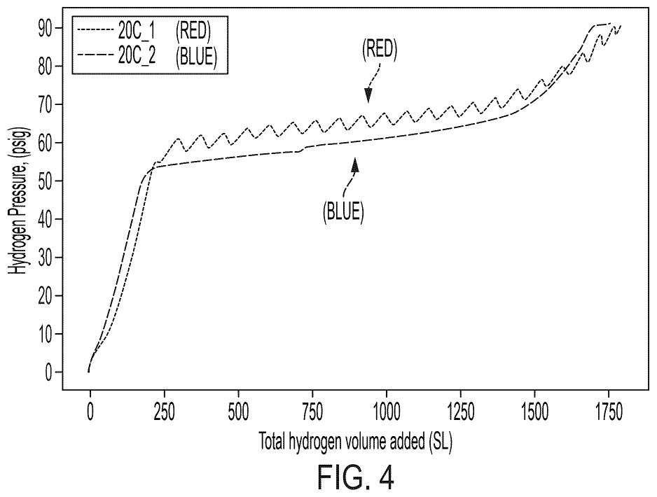

The results from absorption testing conducted using a tank (zone) temperature of 20° C. and a delivery pressure of 90 psig are shown in FIG. 4. This test was conducted twice. The first test is referred to as 20C_1 and the second test is referred to as 20C_2.

For both tests, the steady state addition of hydrogen began after adding approximately 220 L of hydrogen added to the tank. The equilibrium pressure of the first test was 55 psig. The equilibrium pressure of the second test was 54 psig. This gives an average equilibrium pressure of 54.5 psig for the two tests. In test 20C_1, 1,220 L of hydrogen was added during the growth of the α+β and the pressure climbed to 72 psig. During the growth of the α+β phase in test 20C_2 the system also accumulated 1,220 L of hydrogen while only realizing a pressure increase of 13 psig to a total pressure of 68 psig. The rate of pressure change with respect to additional hydrogen volume added to the system during this phase was

$$0.014 \frac{psig}{L}$$

### for 20C_1 and it was

$$0.011 \frac{psig}{L}$$

for 20C_2. The end of the α+β phase was recognized by the rapid increase in pressure with respect to volume of hydrogen added to the system. In the second test the transition was seen at a hydrogen volume of 1,440 L. During the growth of the β phase in 20C_1 the system accumulated an additional 311 L, and the pressure increased to 90 psig, providing a rate of pressure increase of

$$0.058 \frac{psig}{L} .$$

During the growth of the β phase in 20C_2 the system rapidly climbed from 68 psig to 90 psig. This rise in pressure was caused by the addition of 349 L of hydrogen. Comparatively, in 20C_2 this region had a rate of pressure change with respect to hydrogen volume addition of

$$0.063 \frac{psig}{L} .$$

This rate was nearly six times larger than the rate seen in the α+β phase.
Runs at 10° C., 90 psig, and 5 SLPM

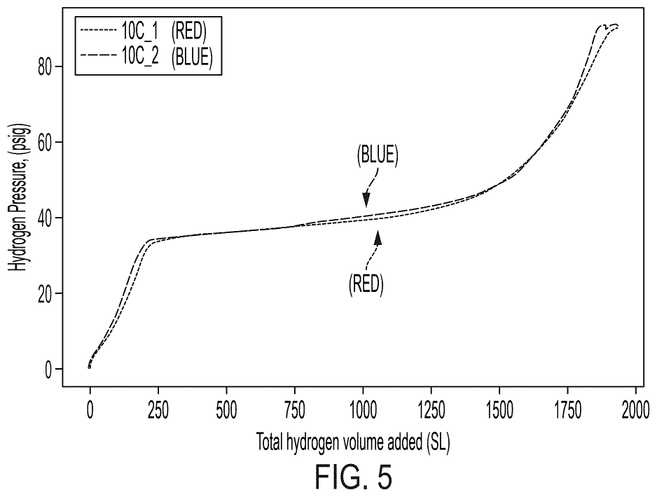

The results from absorption testing conducted using a tank (zone) temperature of 10° C. and a delivery pressure of 90 psig is shown in FIG. 5. This test was repeated twice. The first test was referred to as 10C_1 and the second test as 10C_2. The β phase began growing after a total of 1,400 L of hydrogen was added to the system. During this time the pressure increased from 45 psig to 90 psig. To reach 90 psig, an additional 530 L of hydrogen was added to the tank, until the maximum capacity of 1,930 L was reached. The rate of pressure change during this time was

$$0.085 \frac{psig}{L} .$$

Runs at 5° C., 90 psig, and 5 SLPM

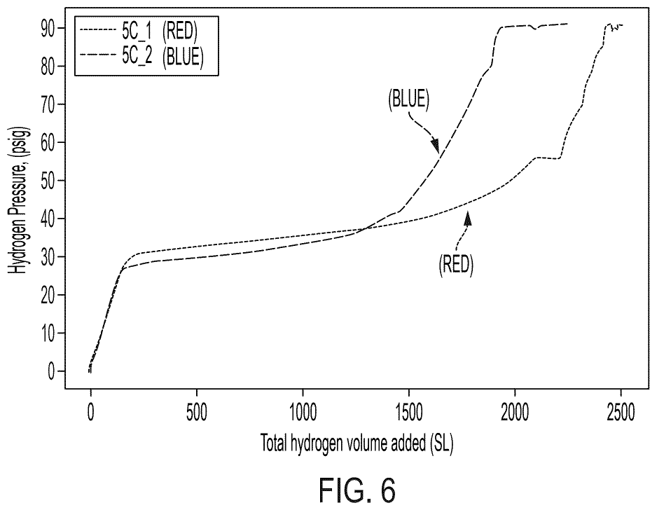

The results from absorption testing conducted using a tank (zone) temperature of 5° C. and a delivery pressure of 90 psig is shown in FIG. 6. Testing under these conditions was repeated twice. The first test was referred to as 5C_1 and the second test as 5C_2. The maximum capacity of 5C_1 was 2,510 L. The maximum capacity of the 5C_2 was 2,238 L. The maximum capacity of both tests at this temperature was larger than the capacity at 10° C. and 20° C. The maximum capacity of 5C_1 was 2,510 L while the maximum capacity of the 5C_2 was 2,238 L. The maximum capacity of both tests at this temperature was still larger than the capacity at 10° C. and 20° C.

Summary of Runs with Mass Flow Meter of 5 SLPM

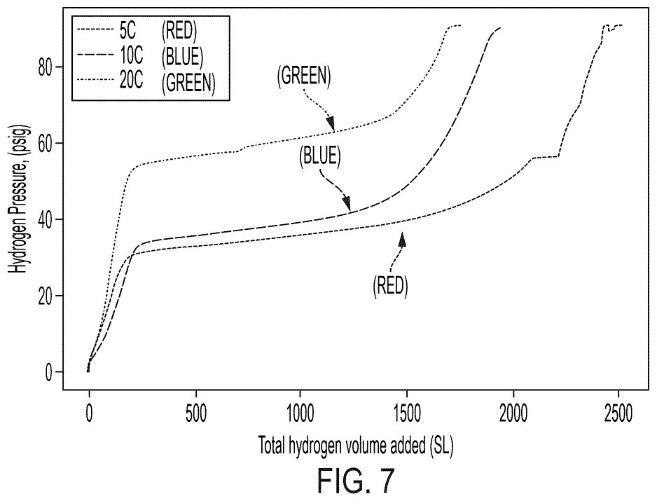

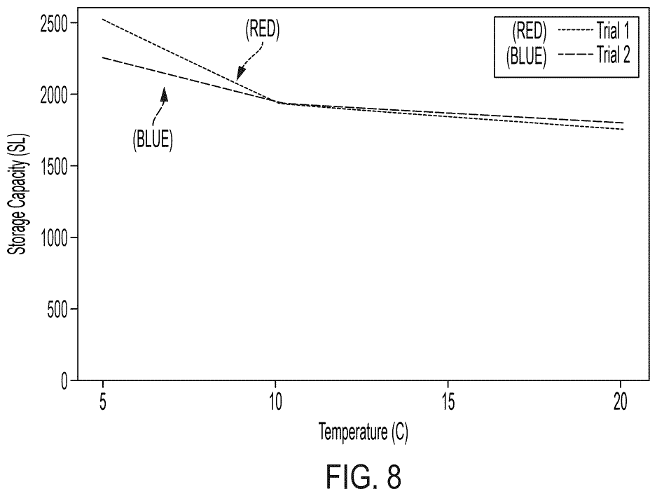

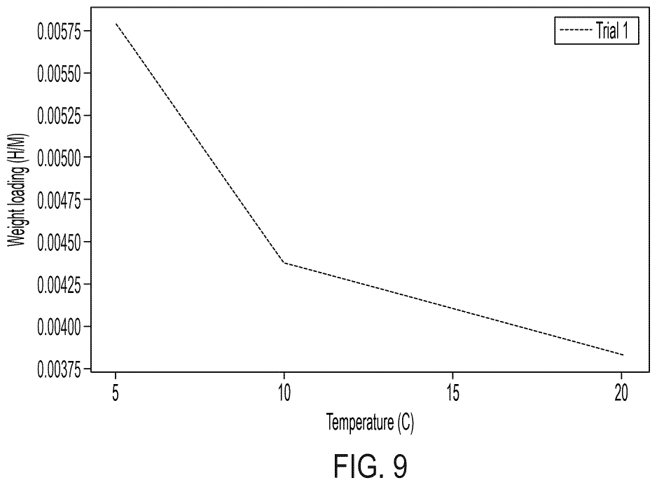

The change in equilibrium pressure with respect to the tank (zone) temperature can be seen in FIG. 7. The equilibrium pressure of the red line (5C_1) was 31 psig, the equilibrium pressure of the blue line (10C_1) was 34 psig, and the equilibrium pressure of the green line (20C_1) was much higher at 55 psig. Lower equilibrium pressure is a desired characteristic of metal hydride storage, such as seen at 5° C. tank temperature. As shown in Table 5 and FIG. 8 the storage capacity of HY-STOR 208 was affected by temperature. When the system was chilled to lower temperatures (i.e., 5° C.) the storage capacity was higher than it was when the system was at higher temperatures (i.e., 20° C.). The increase in storage capacity was more significant at lower temperatures. As shown in Table 1 the rate of absorption was fastest during all phases for tests conducted at 5° C. During the formation of the α and α+β phases it was the lowest for tests conducted at 20° C. During the formation of the β phase, however, the rate of absorption was Lowest for tests conducted at 10° C.

TABLE 1
Summary of the data collected during the open system and low flow rate testing at a
delivery pressure of 90 psig for different cooling temperaturcs.

| Test | Equilibrium Pressure, psig | $\begin{matrix}Rate of pressure change \\ during α phase , \frac{psig}{L}\end{matrix}$ | $\begin{matrix}Rate of pressure change \\ during α + β phase , \frac{psig}{L}\end{matrix}$ | $\begin{matrix}Rate of pressure change \\ during β phase , \frac{psig}{L}\end{matrix}$ | Maximum Capacity, L |
|---|---|---|---|---|---|
| 5C 1 | 31 | 0.13 | 0.0070 | 0.056 | 2510 |
| 5C_2 | 27 | 0.17 | 0.012 | 0.095 | 2238 |
| 10C_1 | 34 | 0.13 | 0.0096 | 0.085 | 1931 |
| 10C_2 | 34 | 0.13 | 0.0096 | 0.085 | 1930 |
| 20C_1 | 55 | 0.25 | 0.014 | 0.063 | 1751 |
| 20C_2 | 54 | 0.25 | 0.011 | 0.058 | 1789 |

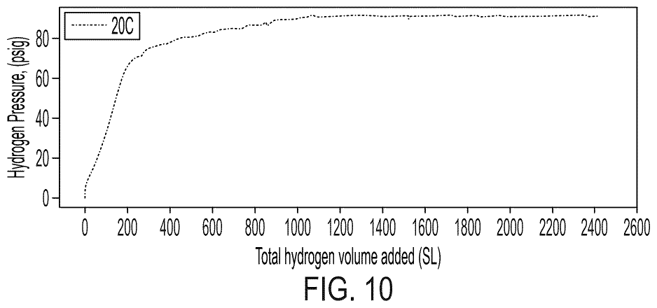

The 37.8 kg of HY-STOR 208 used to store hydrogen in these tests achieved a maximum weight loading of 0.58 wt. % hydrogen at 5° C. Comparatively, this storage method provided excellent energy volume density. As seen in FIG. 10 and Table 5, at 5° C. this storage method could store over 2,000 L of hydrogen at a mild pressure of 90 psig. Furthermore, storing the hydrogen at 5° C. rather than at its condensation point of −252.87° C. was much more energy efficient.

### Effect of Higher Flow Rate

In the previous runs, a mass flow meter with a maximum range of 5 SLPM was used. In this set of tests, the mass flow meter was changed to 20 SLPM to study the effect of higher flow rate on hydrogen absorption. The following set of runs were performed.

Runs at 20° C., 90 psig, and 20 SLPM

A single test was conducted for a given delivery pressure and tank (zone) temperature using this test method. The results from the open system and high flow rate test at 90 psig and a tank temperature of 20° C. is shown in FIG. 10. These results did not show the formation of a distinct α, α+β, or β phase; rather the hydrogen pressure versus total hydrogen volume curve followed a logarithmic growth. The addition of the first 200 L of hydrogen showed a rapid increase in the system pressure. During the addition of the first 200 L of hydrogen the system pressure climbed to 65 psig. After this point, however, the pressure did not climb rapidly with an increase in the total volume of hydrogen added to the system. During the steady state addition of hydrogen, the pressure climbed slowly to 90 psig with an additional 2,214 L. The maximum amount of hydrogen added to the system during this test was 2,414 L. The capacity of the system after being filled at a high flow rate (20 SLPM) was much larger than the capacity of the system at the same temperature and delivery pressure but filled at a lower flow rate (5 SLPM).

Runs at 10° C., 90 psig, and 20 SLPM

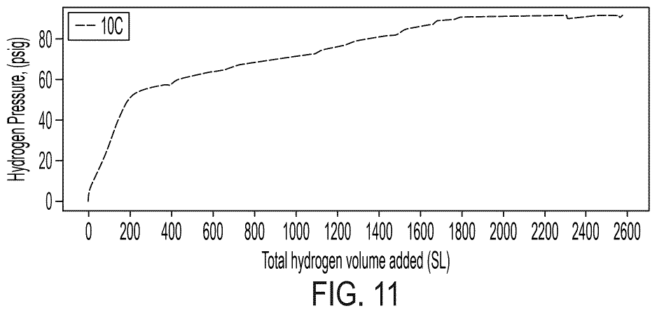

The results from the open system and high flow rate experiment with a delivery pressure of 90 psig and a tank (zone) temperature of 10° C. is shown in FIG. 11. Similar to the results produced using the same method at a tank temperature of 20° C., the results produced at 10° C. follow a logarithmic growth. Furthermore, the addition of the first 200 L of hydrogen once again showed the most rapid rise in system pressure. During this test the system pressure reached 50 psig during the addition of the first 200 L. This was lower than the pressure reached previously when the tank was at 20° C. The difference in pressure at 200 L could be attributed to the quicker rate of absorption seen at 10° C. The maximum capacity of the system under these parameters was 2,574 L of hydrogen. The capacity at 10° C. was higher than the capacity at 20° C. Additionally, the capacity was once again larger when filled more quickly than the capacity of the system when filled at 5 SLPM at the same temperature and delivery pressure.

Runs at 5° C., 90 psig, and 20 SLPM

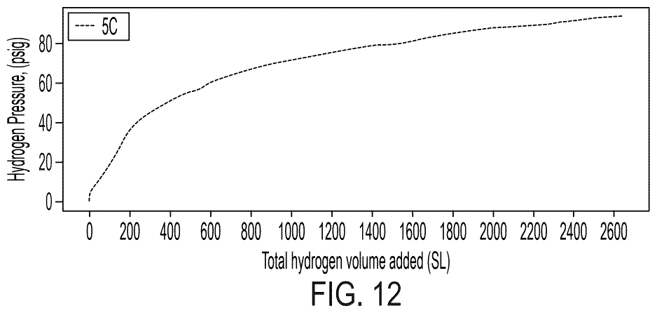

A test conducted using this method at 90 psig was done for a tank (zone) temperature of 5° C. The results of this test are shown in FIG. 12. As seen, the curve followed a logarithmic trend, like the results for the tests at higher temperatures. The pressure of the system during the addition of the first 200 L of hydrogen was the lowest of the three tests at 5° C. The pressure at 200 L was 35 psig. Furthermore, the change in slope realized after the addition of the first 200 L was least significant in this test when compared to tests run at higher temperatures. The maximum capacity of the system when charged at these parameters was 2,639 L. This was the largest capacity of the three tests.

Summary of Temperature Variation Runs at 90 psig and 20 SLPM

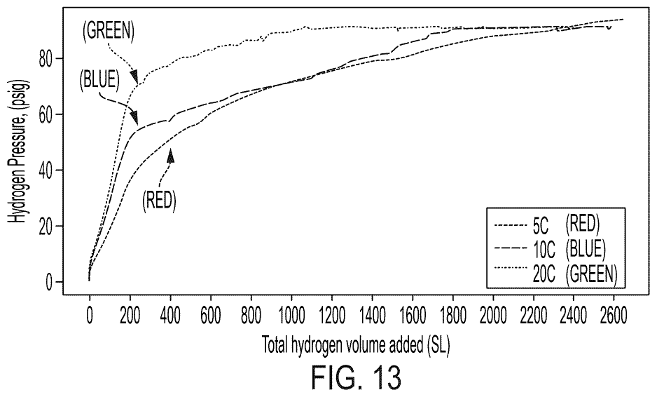

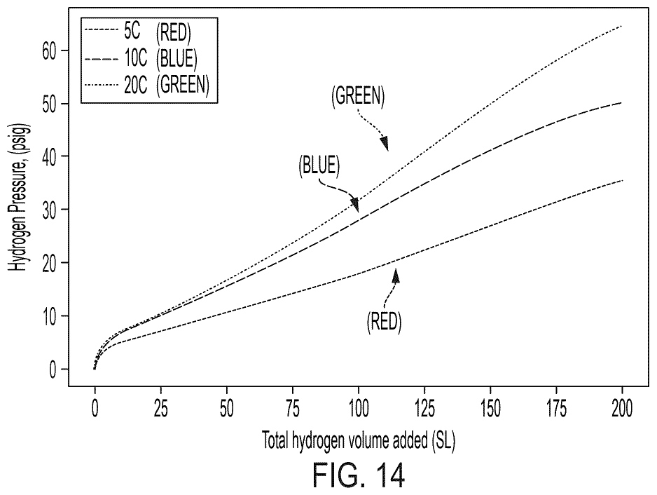

FIG. 13 shows the summary of hydrogen absorption at a delivery pressure of 90 psig for all test temperatures across the entire range of hydrogen volume added to the system. FIG. 14 shows the summary of hydrogen absorption at a delivery pressure of 90 psig for all test temperatures during the addition of the first 200 L of hydrogen. Table 2 shows the summary of data obtained during the open system & high flow rate testing at a delivery pressure of 90 psig

TABLE 2
Summary of data obtained during the open system & high
flow rate testing at a delivery pressure of 90 psig.

| | Pressure after | Volume of | |
|---|---|---|---|
| Temperature, | the first 200 | Absorbed H₂ | Maximum |
| ° C. | L, psig | at 40 psig, L | Capacity, L |
| 5 | 35 | 223.69 | 2,639 |
| 10 | 50 | 130.26 | 2,574 |
| 20 | 65 | 107.42 | 2,414 |

As seen in FIG. 13 the hydrogen pressure was larger at higher tank (zone) temperatures for most values of total hydrogen volume added except for tests conducted at 5° C. and 10° C. at 1,100 L. At this point the pressure of the test at 10° C. dipped below the pressure of the test at 5° C.

Another representation of the influence of tank (zone) temperature on absorption rate can be seen in FIG. 14. In this figure lower tank temperature results in an increase in the absorption rate. After the first 200 L of hydrogen was added to the tank the pressure inside the tank, cooled to 5° C., was lowest at 35 psig. It was the highest at 20° C. when the pressure reached 64 psig after the same volume of hydrogen addition.

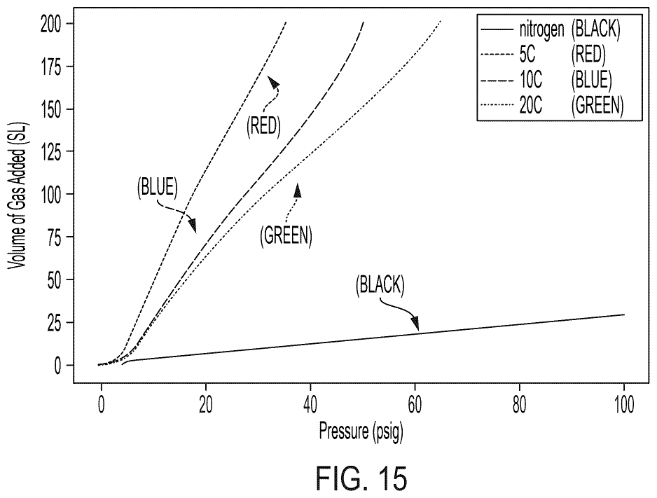

FIG. 15 shows the pressure of the system as the volume of gas added to the system increases. For nitrogen (black line) the system pressure increased rapidly with small volume additions to the tank. This was because nitrogen did not interact with HY-STOR 208, therefore it was not absorbed and remained in the gas phase. For hydrogen, however, the pressure did not increase as rapidly. This was because as hydrogen was added to the storage cylinder, most of it was quickly absorbed by the HY-STOR 208 causing the system pressure to drop. FIG. 15 can be used to determine the volume of hydrogen which had been absorbed at any given pressure. This is done by calculating the difference between the colored line and black line at any given pressure. For example, at 40 psig 11.67 L of nitrogen had been added to the system. At 20° C. the same pressure was reached after 123 L of hydrogen had been added to the system. Therefore, by subtracting the volume of inert nitrogen it can be determined that at 40 psig and 20° C. 111.33 L of hydrogen had been absorbed by HY-STOR 208. The change in nitrogen volume added to the system did not vary significantly with temperature, therefore a single baseline curve at 20° C. is sufficient.

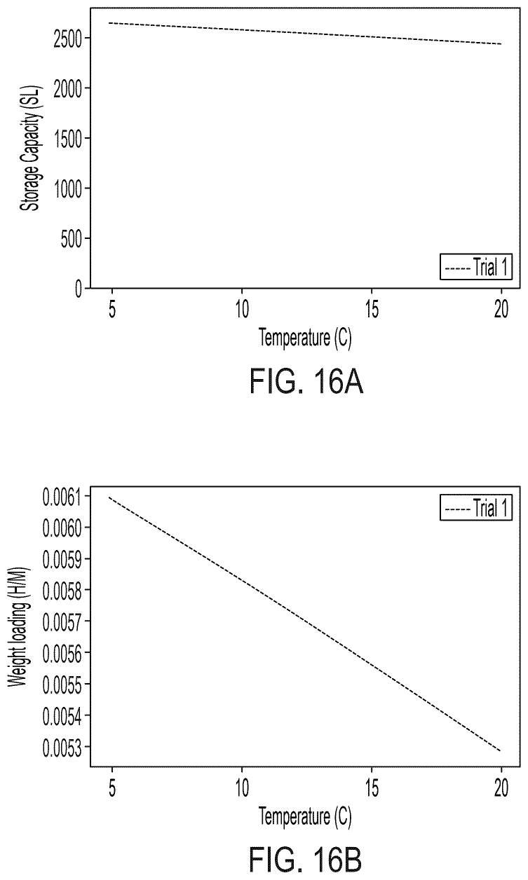

As seen in FIG. 16(a) the volumetric storage capacity of HY-STOR 208 was highest at 5° C. and lowest at 20° C. In FIG. 16(b) the weight loading of hydrogen on Hy-Stor 208 is displayed as a function of the tank temperature. Like volumetric storage capacity, weight loading also decreased linearly with increasing temperature. A maximum weight loading of 0.61 wt. % hydrogen was achieved.

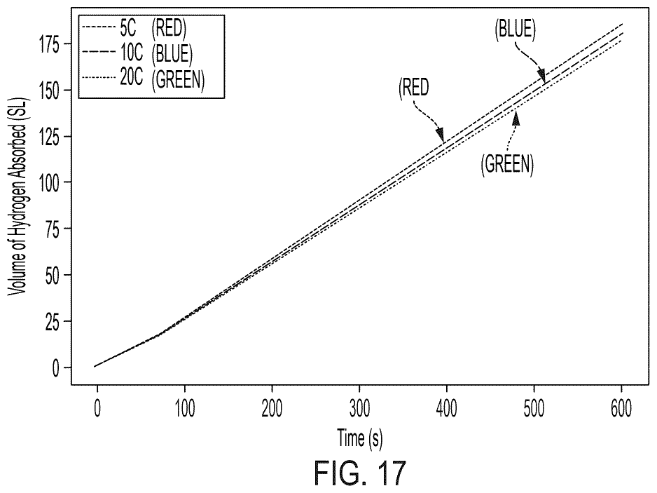

FIG. 17 shows the volume of hydrogen absorbed as a function of time for the system at a delivery pressure of 90 psig. The rate of absorption during the addition of the first 200 L of hydrogen was determined for the three different tank temperatures. The rate of absorption at 5° C. was

$$0.306 \frac{SL}{S}$$

while the rate at 20° C. was

$$0.2918 \frac{SL}{S} .$$

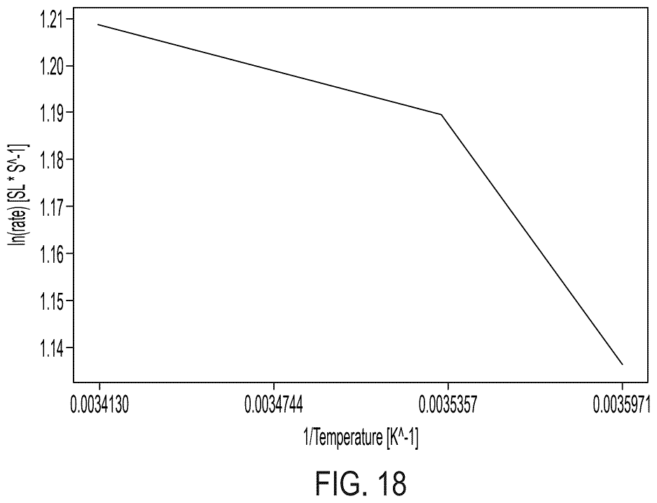

The rate data at each temperature was used to generate the Arrhenius plot shown in FIG. 18. The slope of the Arrhenius plot shown in FIG. 18 was used to determine the activation energy of the system with a delivery pressure 90 psig. From these results the activation energy was calculated to be:

$${E}_{{a}_{90}} = 2 , 41.92 \frac{J}{mol} .$$

### Effect of Lower Pressure

Runs at 20° C., 50 psig, and 20 SLPM

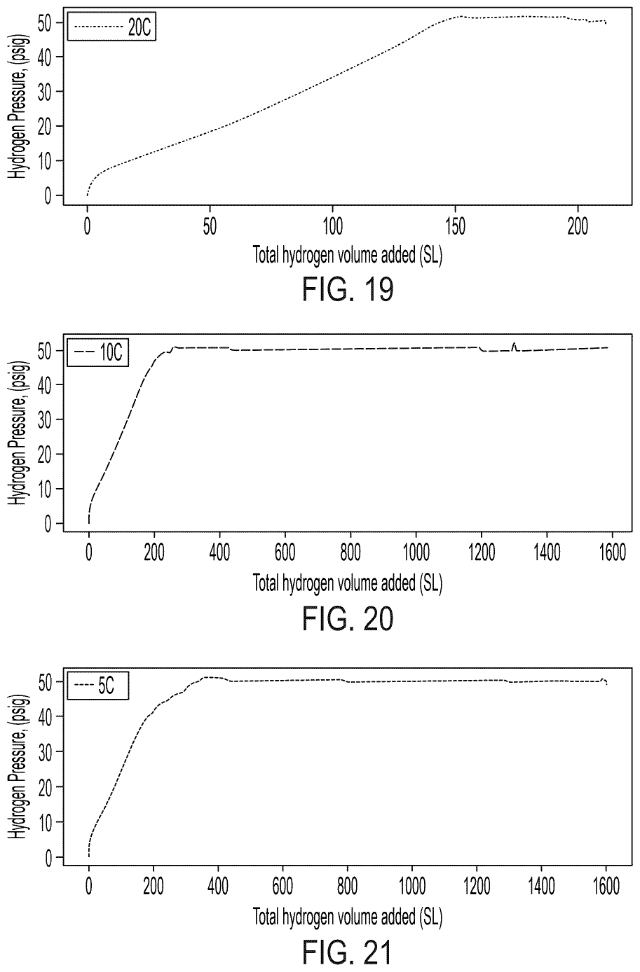

A run was conducted with a lower delivery pressure of 50 psig was done at a tank (zone) temperature of 20° C. The results of that test are shown in FIG. 19. The maximum capacity of the storage system with these charging parameters was the lowest seen in any test at any delivery pressure, temperature, and flow rate. The maximum volumetric storage capacity was 211.33 L of hydrogen. This was lower than the volumetric capacity at 20° C. when the delivery pressure was 90 psig. As the tank was filled the system pressure rose quickly to the delivery pressure doing so after the addition of only 145.53 L. After reaching the delivery pressure the tank slowly continued to fill until the maximum capacity was reached. At the time the tank reached 50 psig the flow rate detected by the mass flow meter was 16.56 SLPM. After an additional 10 L of hydrogen was added to the system the flow rate had dropped significantly to a rate of 7.00 SLPM.

Runs at 10° C., 50 psig, and 20 SLPM

The results obtained from a run at 10° C. and 50 psig are shown in FIG. 20. The maximum storage capacity in this test was 1,584.41 L.

Runs at 5° C., 50 psig, and 20 SLPM

The results of this test are shown in FIG. 21. The maximum volumetric capacity of HY-STOR 208 under these charging conditions was 1,599.27 L. The lower tank temperature indicated a quicker rate of hydrogen absorption at the given delivery pressure.

Summary of Temperature Variation Runs at 50 psig and 20 SLPM

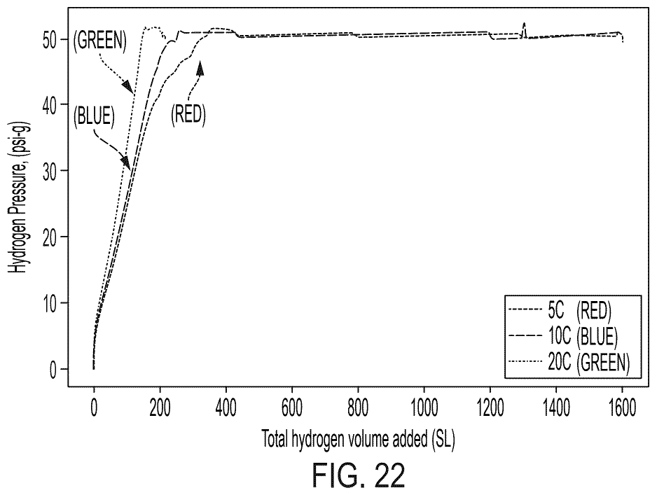

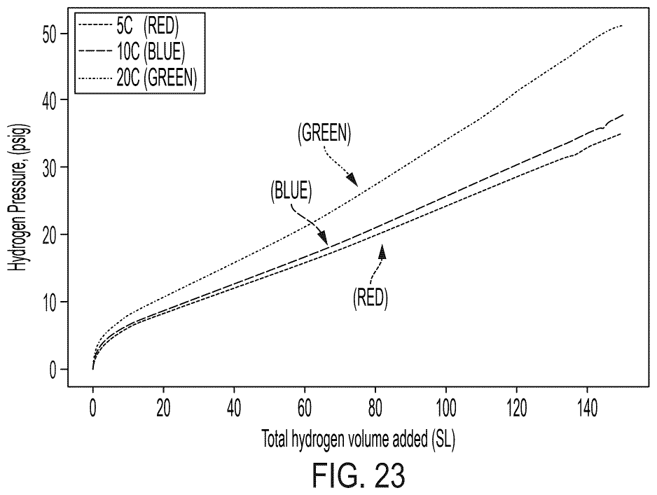

A summary of hydrogen absorption at a delivery pressure of 50 psig for all test temperatures across the entire range of hydrogen volume added to the system is shown at FIG. 22. A summary of hydrogen absorption at a delivery pressure of 50 psig for all test temperatures during the addition of the first 150 L of hydrogen is shown at FIG. 23. A summary of data obtained during the open system & high flow rate testing at a delivery pressure of 50 psig is at Table 3.

TABLE 3
Summary of data obtained during the open system &
high flow rate testing at a delivery pressure of 50 psig.
50 psig Delivery Pressure

| | Pressure after | Volume of | |
|---|---|---|---|
| Temperature, | the first 140 L, | Absorbed H₂ at | Maximum |
| ° C. | psig | 40 psig, L | Capacity, L |
| 5 | 21.07 | 168.54 | 1,599 |
| 10 | 34.87 | 143.95 | 1,584 |
| 20 | 48.57 | 101.4 | 211 |

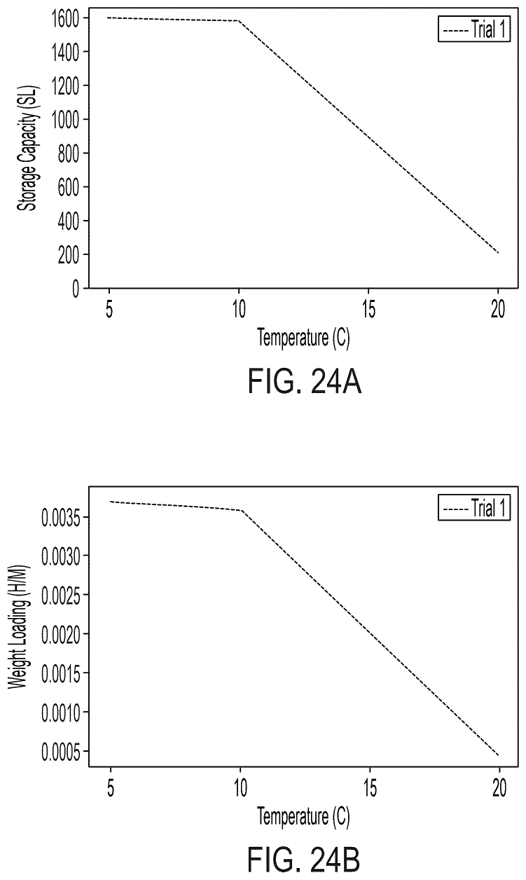

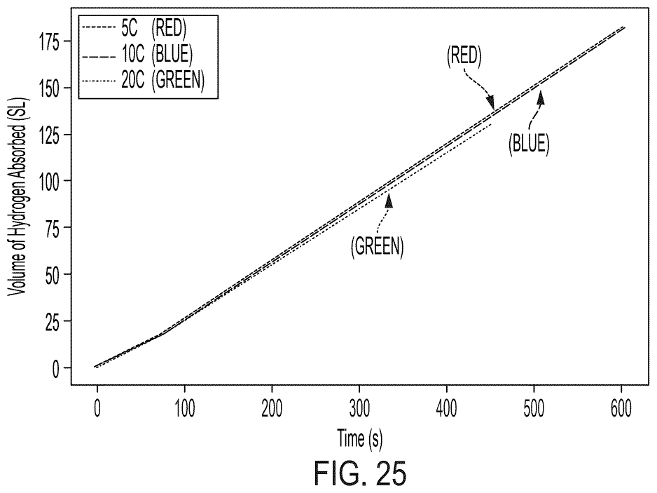

The capacity of the system under these operating parameters was nearly 8 times lower than the capacity of the system at 5 and 10° C. As seen in Table 3 the pressure of the system at each temperature was compared after the addition of the first 140 L of hydrogen. As in Table 2, the system pressure was compared after the addition of the first 200 L. The system at 5° C. showed the quickest absorption rate during this period. The lowest rate was seen for a tank temperature of 20° C. Capacity was largest at 5° C. and lowest at 20° C. The volume of hydrogen absorbed as the system reached 40 psig was highest at 5° C. and lowest at 20° C. FIGS. 24(a) and 24(b) as compared to FIGS. 16(a) and 16(b) showed that the volume of hydrogen absorbed at 90 psig was higher than the volume of hydrogen absorbed at 50 psig for all temperatures. The storage capacity did not change significantly between tank temperatures of 5 and 10° C. The difference in volumetric capacity between 1° and 20° C., however, was extreme. The weight loading of HY-STOR 208 followed the same trend. The maximum weight loading of 0.36 wt. % was achieved at 5° C. Similarly, to the weight loading obtained at a higher delivery pressure, the weight loading at 50 psig was still small. Further reinforcing the strength of HY-STOR 208, which is its high volumetric energy density. Indicating HY-STOR 208 should not be used in applications that require high mass energy density such as automobile fuel. As shown in FIG. 25, the rate of hydrogen absorption was highest at 5° C. and lowest at 20° C. The difference between the rates at the three different temperatures was not large. This is especially true for the rate of absorption for the system at tank temperatures of 5 and 10° C. The lowest rate of absorption is

$$0.2871 \frac{L}{S}$$

while the highest rate seen at 5° C. is

$$0.3014 \frac{L}{S} .$$

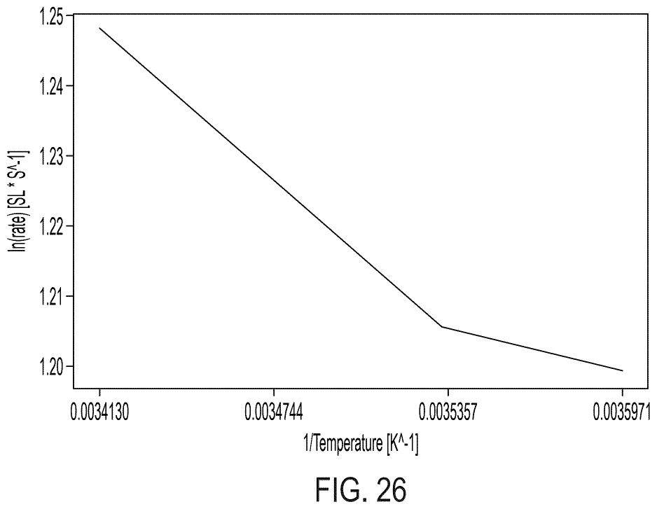

The rate of absorption was only calculated for the addition of the first 200 L of hydrogen to the system. An evalutation of the Arrhenius plot shown in FIG. 26 was done to determine the activation energy of the absorption reaction at a delivery pressure of 50 psig. The activation energy was calculated to be:

$${E}_{{a}_{50}} = 2 , 288.93 \frac{J}{mol} .$$

### Comparison of the Results Obtained at 50 and 90 Psig

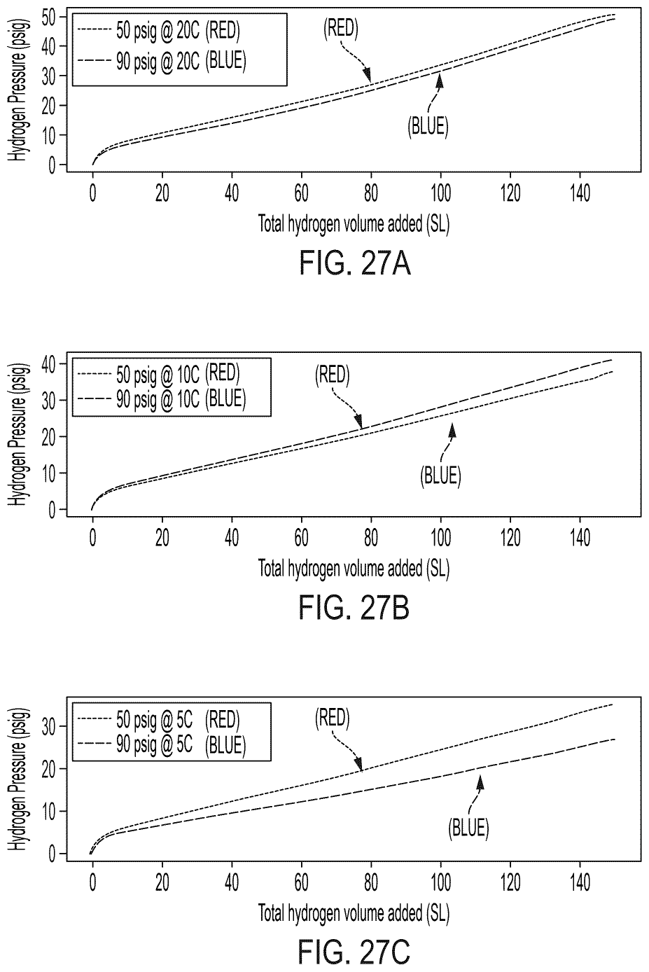

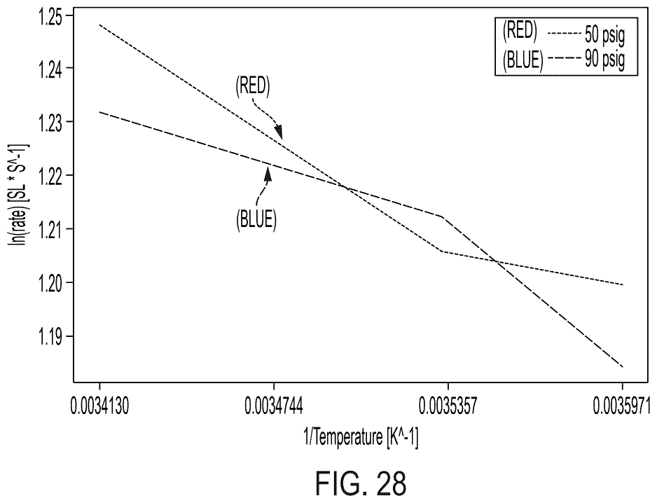

To investigate the influence of delivery pressure on the absorption of hydrogen on HY-STOR 208 the results obtained at 50 and 90 psig were compared. Results were compared for the addition of the first 140 L. Results are shown in FIGS. 27(a), 27(b) and 27(c) where FIG. 27(a) shows results of absorption at 20° C.; FIG. 27(b) shows results of absorption at 10° C.; and FIG. 27(c) shows results of absorption at 5° C. Data obtained at 50 psig is shown in red. Data obtained at 90 psig is shown in blue. For tests performed at 20° C. and 5° C. the absorption rate was higher at 90 psig when compared to the rate at 50 psig across the entire range. The largest difference in rate between two tests at the same temperature was seen at 5° C. Analysis of the results of the Arrhenius plot obtained for both delivery pressures was in good agreement with the rate data is shown in FIG. 28. In FIG. 28, the rate was higher at 5 and 20° C. but lower at 10° C. when the system was filled with a delivery pressure of 50 psig.

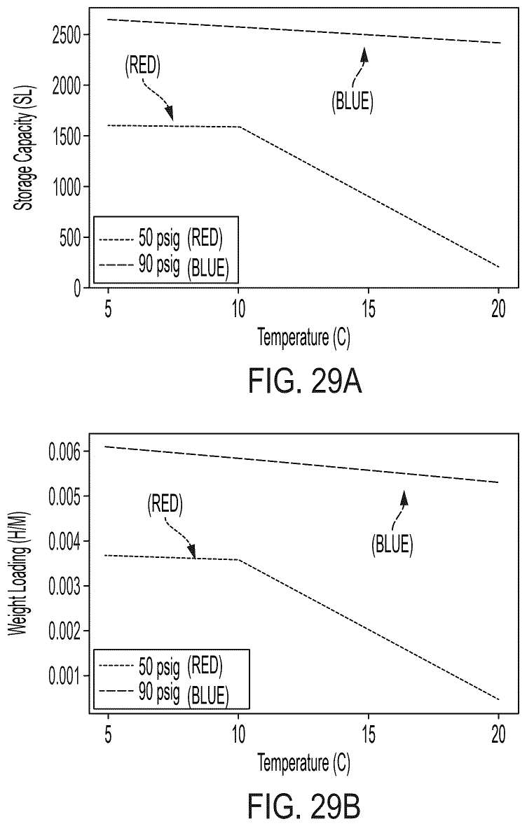

The capacity of the system realized the largest influence from a change in delivery pressure. As shown in FIGS. 29(a) and 29(b), at higher delivery pressures both the volumetric capacity and weight loading is higher across all temperatures. There was approximately a 1,000 L difference in volumetric capacity at both 5 and 10° C. Table 4 summarizes the absorption obtained at both delivery pressures.

TABLE 4
Summary of the absorption obtained at both delivery pressures.

| | 50 psig | | | 90 psig | | |
|---|---|---|---|---|---|---|
| Temperature (°C) | $Activation Energy , \frac{J}{mol}$ | $Rate of Absorption , \frac{L}{s}$ | Maximum Capacity, L | $Activation Energy , \frac{J}{mol}$ | $Rate of Absorption , \frac{L}{s}$ | Maximum Capacity, L |
| 5 | 2,288.93 | 0.3014 | 1,599 | 2,041.92 | 0.3060 | 2,639 |
| 10 | | 0.2995 | 1,584 | | 0.2976 | 2,574 |
| 20 | | 0.2871 | 211 | | 0.2918 | 2,414 |

### List of Abbreviations Used Herein

AERTC—Advanced Energy Research and Technology Center
I-GIT—Institute of Gas Innovation and Technology
SLPM—Standard Liter Per Minute
L—Standard Liter
DAQ—Data Acquisition
SCF—Standard Cubic Feet
Pₑ—Equilibrium pressure
P-C-T—Pressure—Composition—Temperature
H₂—Hydrogen
N₂—Nitrogen
CO₂—Carbon Dioxide
CO—Carbon Monoxide
Mm—Mischmetal
Ce—Cerium
La—Lanthanum
Nd—Neodymium
Pr—Praseodymium
Wt. %=Weight percent
M—Mass of Hy-Stor 208
H—Mass of Hydrogen
Psig—Pound force per square inch gauge
Psia—Pound force per square inch absolute
MSDS—Material Safety Data Sheet

What is claimed is:

1. A method for separating hydrogen and methane from a gaseous mixture comprising hydrogen and methane, the method comprising:
(i) providing a zone comprising an activated mixed metal hydride;
(ii) passing a flowing gaseous mixture comprising hydrogen and methane through the zone to contact the activated metal hydride under conditions effective to absorb at least a portion of the hydrogen without absorbing a detectable amount of the methane; and
(iii) exiting the unabsorbed methane from the zone, the unabsorbed methane substantially free of hydrogen.

2. The method of claim 1 wherein the unabsorbed methane of step (iii) contains no more than 100 ppm hydrogen.

3. The method of claim 1 further comprising (iv) desorbing the hydrogen from the mixed metal hydride; and (v) exiting the desorbed hydrogen from the zone, the desorbed hydrogen containing no detectable amount of methane.

4. The method of claim 3 wherein the desorbing step (iv) comprises increasing the temperature of the mixed metal hydride to about 40° C. to about 120° C.

5. The method of claim 3 wherein the method is cycled by repeating steps (ii), and (iii) after step (v).

6. The method of claim 1 wherein the absorbed hydrogen in step (ii) is stored in the activated mixed metal hydride for a period of time up to one year.

7. The method of claim 1 wherein the gaseous mixture comprises natural gas, wherein the natural gas comprises one or more of the following impurities: hydrogen sulfide, ammonia, a mercaptan.

8. The method of claim 7 further comprising passing the gaseous mixture comprising hydrogen and methane through a sulfur guard prior to step (ii) to remove or reduce the amount of the impurities in the natural gas.

9. The method of claim 3 wherein the desorbed hydrogen exiting the zone is used or is stored in one or more vessels.

10. The method of claim 1 wherein the conditions effective comprise a temperature of about 5° C. to about 70° C., a pressure of about 50 psig to about 90 psig, and a flow rate of about 5 to about 20 Standard Liters Per Minute (SLPM).

11. The method of claim 10 wherein the temperature is about 5° C., the pressure is about 90 psig, and the flow rate is about 20 SLMP.

12. The method of claim 1 wherein the mixed metal hydride comprises a mischmetal aluminum alloy.

13. The method of claim 12 wherein the mischmetal aluminum alloy comprises a composition having the formula MmNi_{4.5}Al_{0.5}, wherein Mm represents 49% cerium (Ce), 33% lanthanum (La), 14% neodymium (Nd), and 4% praseodymium (Pr) by weight.

14. The method of claim 13 wherein the mixed metal hydride has been activated by (a) exposing it to a temperature of about 100° C. to 120° C. under a nitrogen atmosphere for about 1 to about 6 hours, or (b) exposing it a temperature of about 60° C. to 80° C. under vacuum for about 1 to about 6 hours, or a combination of (a) and (b).

15. A system for separating hydrogen and methane from a mixture comprising hydrogen and methane, the system comprising:
a zone comprising an activated mixed metal hydride;
a first temperature controller to maintain the temperature in the zone at about 5° C. to about 70° C.;
a source providing a mixture comprising gaseous hydrogen and methane to the zone at a flow rate of about 5 to about 20 Standard Liters Per Minute (SLPM) and a pressure of about 50 psig to about 500 psig, the source in fluid communication with the zone, wherein at least a portion of the hydrogen is absorbed in the activated metal hydride without substantially absorbing a detectable amount of the methane; and
an outlet from the zone whereby the unabsorbed methane substantially free of hydrogen exits the zone, and optionally at least one of the following: one or more collection stations for storing the unabsorbed methane substantially free of hydrogen that exits the zone, or one or more collection stations for storing the desorbed hydrogen that exits the zone.

16. The system of claim 12 further comprising a second temperature controller to increase the temperature of the zone so as to desorb the hydrogen from the mixed metal hydride, wherein the first temperature controller and the second temperature controller can be the same or different.

17. The system of claim 15 wherein the mixed metal hydride comprises a mischmetal aluminum alloy.

18. The system of claim 17 wherein the mischmetal aluminum alloy comprises a composition having the formula MmNi_{4.5}Al_{0.5}, wherein Mm represents 49% cerium (Ce), 33% lanthanum (La), 14% neodymium (Nd), and 4% praseodymium (Pr) by weight.

19. The system of claim 12 further comprising a sulfur guard having an inlet connected to the source providing the mixture comprising gaseous hydrogen and methane, and an outlet connected to the zone comprising the activated mixed metal hydride.

20. The system of claim 19 wherein the source providing the mixture comprising gaseous hydrogen and methane comprises a source of natural gas, wherein the natural gas comprises one or more of the following impurities: hydrogen sulfide, ammonia, a mercaptan.
